(19) United States
(12) Patent Application Publication
(10) Pub. No.: US 2015/0077582 A1
(43) Pub. Date: Mar. 19, 2015

(54) METHOD AND SYSTEM FOR ADAPTING A DEVICE FOR ENHANCEMENT OF IMAGES

(71) Applicant: Texas Instruments Incorporated, Dallas, TX (US)

(72) Inventor: Buyue Zhang, Plano, TX (US)

(73) Assignee: Texas Instruments Incorporated, Dallas, TX (US)

(21) Appl. No.: 14/026,548

(22) Filed: Sep. 13, 2013

(51) Int. Cl. H04N 5/232; H04W 4/02

(52) U.S. Cl. CPC H04N 5/23229; H04W 4/028
USPC 348/222.1

(57) ABSTRACT

A device stores a list of geographic regions and respective sets of device parameters for achieving target visual characteristics thereof. One of the geographic regions is selected. In response to the selected geographic region's respective set of device parameters, the device automatically adapts for achieving the selected geographic region's target visual characteristics in the device's enhancement of images. At least one of the images is enhanced with the adapted device.

### BACKGROUND

The disclosures herein relate in general to image processing, and in particular to a method and system for adapting a device for enhancement of images.

Within different geographic regions, a majority of people may subjectively prefer different visual characteristics (e.g., color, skin tone, brightness, contrast, and sharpness) of images (e.g., a video sequence of images). For example, due to cultural differences and other factors: (a) a majority of people in Asia may subjectively prefer images to have a neutral-to-slight bluish overall tone for indoor scenes, a fair (e.g., light or slightly pale) skin tone, and/or greater brightness; and (b) by comparison, a majority of people in North America may subjectively prefer images to have a slight reddish overall tone for indoor scenes, a warmer skin tone, and/or greater contrast.

Accordingly, when a manufacturer tunes its digital cameras (e.g., integral with mobile smartphones) at a factory or engineering facility, the manufacturer may be unable to achieve such tuning in a way that satisfies everyone's subjective preferences around the world. Instead, the manufacturer could tune its digital cameras based upon such manufacturer's own subjective preferences, which is potentially influenced by such manufacturer's own geographic region. Nevertheless, if an Asian manufacturer tunes its digital cameras based upon typical Asian preferences, then such cameras may be less appealing to North American customers. Similarly, if a North American manufacturer tunes its digital cameras based upon typical North American preferences, then such cameras may be less appealing to Asian customers.

### SUMMARY

A device stores a list of geographic regions and respective sets of device parameters for achieving target visual characteristics thereof. One of the geographic regions is selected. In response to the selected geographic region's respective set of device parameters, the device automatically adapts for achieving the selected geographic region's target visual characteristics in the device's enhancement of images. At least one of the images is enhanced with the adapted device.

### BRIEF DESCRIPTION OF THE DRAWINGS

FIG. 1 is a perspective view of an information handling system of the illustrative embodiments.

FIG. 2 is a block diagram of the information handling system of the illustrative embodiments.

FIG. 3 is a flowchart of an operation of the information handling system of the illustrative embodiments.

### DETAILED DESCRIPTION

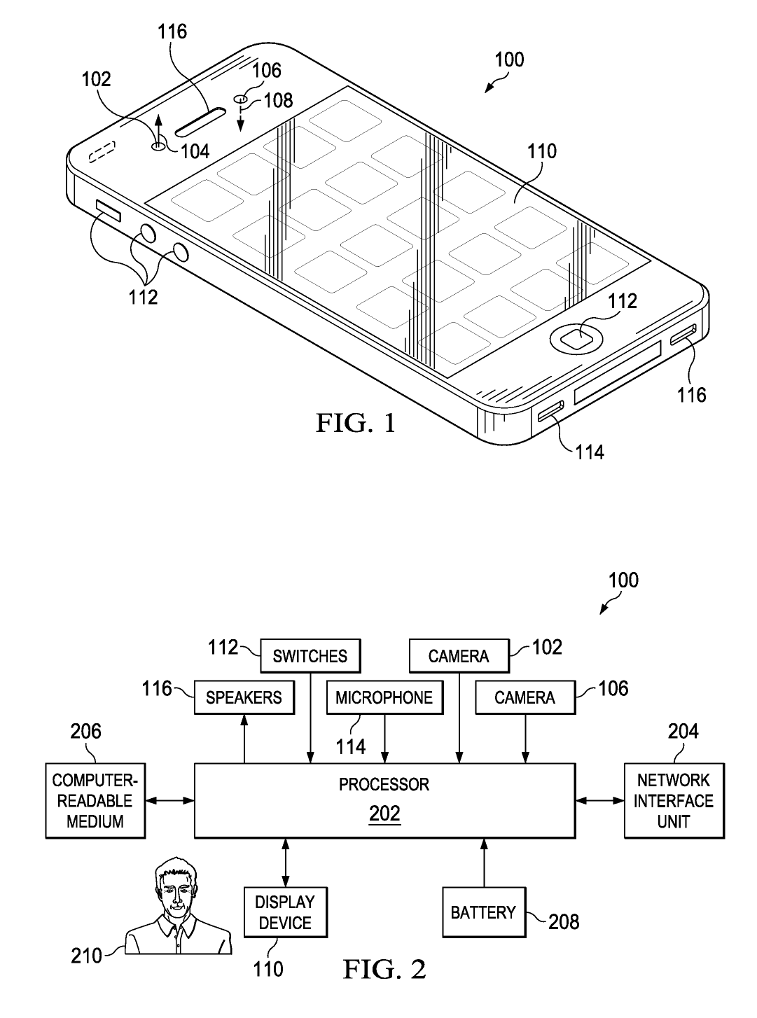

FIG. 1 is a perspective view of an information handling system 100 of the illustrative embodiments. In this example, as shown in FIG. 1, a device of the system 100 includes: (a) on a front of the system 100, a front-facing digital camera 102 that points in a direction of an arrow 104; and (b) on a back of the system 100, a rear-facing digital camera 106 that points in a direction of an arrow 108, which is substantially opposite the direction of the arrow 104. In response to one or more commands from a human user, the cameras 102 and 106: (a) view scenes (e.g., a physical object and its surrounding foreground and background); (b) capture and digitize images of those views; and (c) output those digitized (or “digital”) images.

Also, the system 100 includes a display device 110 (on the front of the system 100) and various switches 112 for the human user to manually control operations of the system 100. A touchscreen of the display device 110 faces in a direction that is substantially parallel to the arrow 104. Moreover, the system 100 includes: (a) a microphone 114; and (b) speakers 116, such as an ear speaker and a loud speaker.

FIG. 2 is a block diagram of the system 100. The system 100 includes various components (e.g., electronic circuitry components) for performing the system 100 operations, implemented in a suitable combination of hardware, firmware and software. In the illustrative embodiments, those various components are housed integrally with one another.

Such components include a processor 202 (e.g., one or more microprocessors and/or digital signal processors), which is a general purpose computational resource for executing instructions of computer-readable software programs to: (a) process data (e.g., a database of information); and (b) perform additional operations (e.g., communicating information) in response thereto. Also, such components include a network interface unit 204 for: (a) communicating information to and from a network in response to signals from the processor 202; and (b) after receiving information from the network, outputting such information to the processor 202, which performs additional operations in response thereto. Further, such components include a computer-readable medium 206, such as a nonvolatile storage device and/or a random access memory (“RAM”) device, for storing those programs and other information.

A battery 208 is a source of power for the system 100. As shown in FIG. 2, the processor 202 is connected to the battery 208, the computer-readable medium 206, the display device 110, the switches 112, the microphone 114, the speakers 116, and the cameras 102 and 106. For clarity, although FIG. 2 shows the battery 208 connected to only the processor 202, the battery 208 is further coupled to various other components of the system 100.

The system 100 operates in association with a human user 210. For example, the switches 112 output signals (indicative of manual commands from the user 210) to the processor 202, which performs additional operations in response thereto. Moreover, the display device 110 includes a touchscreen (FIG. 1) for displaying visual images (e.g., which represent information) in response to signals from the processor 202, so the user 210 is thereby enabled to view the visual images on the touchscreen.

In one embodiment, the touchscreen is: (a) a liquid crystal display (“LCD”) device; and (b) touch-sensitive circuitry of such LCD device, so that the touch-sensitive circuitry is integral with such LCD device. Accordingly, the user 210 operates the touchscreen (e.g., virtual keys thereof, such as a virtual keyboard and/or virtual keypad) for specifying information (e.g., alphanumeric text information, such as commands) to the processor 202, which receives such information from the touchscreen. For example, the touchscreen: (a) detects presence and location of a physical touch (e.g., by a finger of the user 210, and/or by a passive stylus object) within a display area of the touchscreen; and (b) in response thereto, outputs signals (indicative of such detected presence and location) to the processor 202. In that manner, the user 210 can: (a) touch (e.g., single tap and/or double tap) a portion of a visual image that is then-currently displayed by the touchscreen; and (b) thereby cause the touchscreen to output various information to the processor 202, which performs additional operations in response thereto.

The microphone 114: (a) converts sound waves (e.g., speech from the user 210, and noise from an ambient environment surrounding the system 100) into voltage signals; and (b) outputs those voltage signals to the processor 202, which performs additional operations in response thereto. The speakers 116 output sound waves (e.g., audible to the user 210) in response to signals from the processor 202. Further, the system 100 includes other electronic circuitry for performing additional operations of the system 100.

Also, the processor 202 is coupled through the network interface unit 204 to the network (not shown in FIG. 2), such as a Transport Control Protocol/Internet Protocol (“TCP/IP”) network (e.g., the Internet or an intranet). Accordingly, the network interface unit 204 communicates by outputting information to, and receiving information from, the processor 202 and the network, such as by transferring information (e.g. instructions, data, signals) between the processor 202 and the network (e.g., wirelessly or through a USB interface). In one embodiment, the processor 202: (a) receives global positioning system (“GPS”) signals from the network interface unit 204; and (b) in response to those signals, determines a geographic region of the system 100.

The cameras 102 and 106 output their captured digital images (e.g., a video sequence of captured digital images) to the processor 202, which receives those images, such as in response to one or more commands from the user 210 (e.g., commands via the display device 110 and/or the switches 112). In the illustrative embodiments, the system 100: (a) enhances those images by modifying their visual characteristics (e.g., color, skin tone, brightness, contrast, and sharpness), in response to subjectively preferred targets for those characteristics; and (b) writes those enhanced images for storage on the computer-readable medium 206. For example: (a) if the user 210 operates the system 100 within a first geographic region, then the user 210 could be more likely to subjectively prefer a first set of visual characteristics for the system 100 to target in such enhancement (“first set of target visual characteristics”); and (b) by comparison, if the user 210 operates the system 100 within a second geographic region, then the user 210 could be more likely to subjectively prefer a second set of visual characteristics for the system 100 to target in such enhancement (“second set of target visual characteristics”).

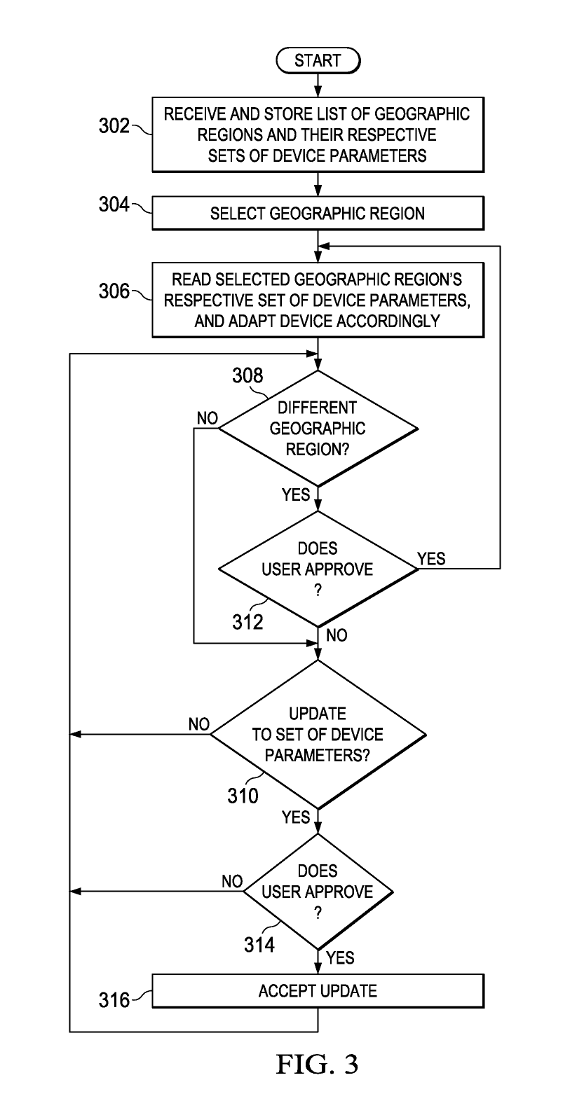

FIG. 3 is a flowchart of an operation of the system 100. At a step 302, the system 100 receives and stores (e.g., on the computer-readable medium 206) a list of geographic regions and respective sets of device parameters (e.g., parameters for software and/or hardware of the system 100) for achieving their respective target visual characteristics. At a next step 304, the system 100 selects one of those geographic regions (“selected geographic region”).

In one example, the steps 302 and 304 are performed while the system 100 is located at a factory, where the system 100 is assembled by a manufacturer. In such example, by commands (e.g., via the display device 110, the switches 112, and/or the network interface unit 204), the manufacturer specifies: (a) at the step 302, the list of geographic regions and the respective sets of device parameters for achieving their respective target visual characteristics; and (b) at the step 304, the selected geographic region, irrespective of a then-current actual location of the system 100. Accordingly, if the manufacturer assembles the system 100 for eventual distribution to a customer in North America, then the manufacturer can specify (by such commands) North America as being the selected geographic region, even if a then-current actual location of the system 100 is a factory in Asia.

In the illustrative embodiments, although the geographic regions have respective sets of device parameters for achieving their respective target visual characteristics, two or more geographic regions may happen to share identical (or similar) sets of device parameters. In a first example, the geographic regions include Asia, Europe, North America, South America, Africa, and other continents. In a second example, the geographic regions include smaller areas, such as cities and/or other types of locations (e.g., office, home, retail store, public recreational area).

After the step 304, the operation continues to a step 306. At the step 306, the system 100 reads (e.g., from the computer-readable medium 206) the selected geographic region's respective set of device parameters for achieving such region's target visual characteristics. Further, at the step 306, in response to those device parameters, the system 100 automatically adapts itself (e.g., adapts software and/or hardware of the system 100, such as the cameras 102 and 106) for achieving those characteristics in its enhancement of images.

At a next step 308, the system 100 determines whether a different geographic region is identified. For example, the system 100 determines that a different geographic region is identified if: (a) the system 100 automatically determines (e.g., in response to GPS signals from the network interface unit 204) that it has moved from the selected geographic region to a different geographic region (outside the selected geographic region), so that the different geographic region includes a then-current actual location of the system 100; or (b) the system 100 receives a suitable command that identifies the different geographic region, such as a suitable command from the user 210 (e.g., via the display device 110 and/or the switches 112) or a suitable command from a system administrator (e.g., via the network interface unit 204), irrespective of a then-current actual location of the system 100. Accordingly, even if the system 100 is unable to automatically determine its then-current actual location, the user 210 (or the system administrator) can specify the different geographic region by the suitable command.

In response to the system 100 determining (at the step 308) that a different geographic region is not identified, the operation continues from the step 308 to a step 310. Conversely, in response to the system 100 determining (at the step 308) that a different geographic region is identified, the operation continues from the step 308 to a step 312. At the step 312, the system 100 determines whether the user 210 approves the different geographic region.

For example, in response to the system 100 automatically determining (at the step 308) that it has moved from the selected geographic region to a different geographic region, or in response to the system 100 receiving (at the step 308) the suitable command from the system administrator that identifies the different geographic region, the system 100 (at the step 312): (a) displays a message on the display device 110 to ask whether the user 210 approves the different geographic region; and (b) from the user 210 (e.g., via the display device 110 and/or the switches 112), receives the answer to such message. By comparison, in response to the system 100 receiving (at the step 308) the suitable command from the user 210 that identifies the different geographic region, the system 100 (at the step 312) automatically determines that the user 210 approves the different geographic region.

In response to the system 100 determining (at the step 312) that the user 210 approves the different geographic region, the system 100 accepts the different geographic region to become the selected geographic region, and the operation returns from the step 312 to the step 306. Conversely, in response to the system 100 determining (at the step 312) that the user 210 disapproves the different geographic region, the system 100 rejects the different geographic region from becoming the selected geographic region, and the operation continues from the step 312 to the step 310.

At the step 310, the system 100 determines whether it has received an update to a particular geographic region's (e.g., the selected geographic region's) respective set of device parameters for achieving such region's target visual characteristics. For example, the system 100 determines that it has received such update if the system 100 receives a suitable command with such update from a system administrator (e.g., via the network interface unit 204). Accordingly, the system administrator can specify such update by: (a) revising the particular geographic region's respective set of device parameters; (b) generating such update to incorporate those revisions; and (c) transmitting the suitable command with such update to the system 100 (e.g., via the network interface unit 204). Also, the user 210 can trigger such update by one or more suitable commands (e.g., via the display device 110 and/or the switches 112) for: (a) revising the particular geographic region's target visual characteristics; and (b) causing the system 100 to request such update by transmitting those revisions to the system administrator (e.g., via the network interface unit 204), so that the system administrator will specify such update in response to those revisions.

In response to the system 100 determining (at the step 310) that it has not received such update, the operation returns from the step 310 to the step 308. Conversely, in response to the system 100 determining (at the step 310) that it has received such update, the operation continues from the step 310 to a step 314. At the step 314, the system 100 determines whether the user 210 approves such update. For example, in response to the system 100 receiving (at the step 310) the suitable command with such update from the system administrator, the system 100 (at the step 314): (a) displays a message on the display device 110 to ask whether the user 210 approves such update; and (b) from the user 210 (e.g., via the display device 110 and/or the switches 112), receives the answer to such message.

In response to the system 100 determining (at the step 314) that the user 210 disapproves such update, the system 100 rejects such update, and the operation returns from the step 314 to the step 308. Conversely, in response to the system 100 determining (at the step 314) that the user 210 approves such update, the operation continues from the step 314 to a step 316. At the step 316, the system 100 accepts such update by accordingly revising the particular geographic region's respective set of device parameters for achieving such region's target visual characteristics. After the step 316, the operation returns to the step 308.

In that manner, the system 100 automatically adapts itself (e.g., adapts software and/or hardware of the system 100, such as the cameras 102 and 106) and is more likely to satisfy a user's subjective preferences for enhancement of images, wherever the user may happen to be located.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method performed by at least one device for enhancement of images, the method comprising:
storing a list of geographic regions and respective sets of device parameters for achieving target visual characteristics thereof;
selecting one of the geographic regions;
in response to the selected geographic region's respective set of device parameters, automatically adapting the device for achieving the selected geographic region's target visual characteristics in the device's enhancement of the images; and
enhancing at least one of the images with the adapted device.

2. The method of claim 1, and comprising:
accepting a different geographic region to become the selected geographic region.

3. The method of claim 2, wherein accepting the different geographic region includes:
determining that the device has moved from the selected geographic region to the different geographic region, so that the different geographic region includes a then-current actual location of the device, wherein the different geographic region is outside the selected geographic region; and
in response to determining that the device has moved from the selected geographic region to the different geographic region, accepting the different geographic region to become the selected geographic region.

4. The method of claim 3, wherein accepting the different geographic region includes:
in response to determining that the device has moved from the selected geographic region to the different geographic region, determining whether a user approves the different geographic region; and
in response to determining that the user approves the different geographic region, accepting the different geographic region to become the selected geographic region.

5. The method of claim 2, wherein accepting the different geographic region includes:
in response to a command that identifies the different geographic region, accepting the different geographic region to become the selected geographic region.

6. The method of claim 5, wherein accepting the different geographic region includes:
in response to the command, determining whether a user approves the different geographic region; and
in response to determining that the user approves the different geographic region, accepting the different geographic region to become the selected geographic region, irrespective of a then-current actual location of the device.

7. The method of claim 1, and comprising:
revising a particular geographic region's respective set of device parameters.

8. The method of claim 7, wherein revising the particular geographic region's respective set of device parameters includes:
receiving an update to the particular geographic region's respective set of device parameters; and
revising the particular geographic region's respective set of device parameters according to the update.

9. The method of claim 8, wherein revising the particular geographic region's respective set of device parameters includes:
determining whether a user approves the update; and
in response to determining that the user approves the update, revising the particular geographic region's respective set of device parameters according to the update.

10. The method of claim 1, wherein the selected geographic region is different from a then-current actual location of the device.

11. A system for enhancement of images, comprising:
at least one device for: storing a list of geographic regions and respective sets of device parameters for achieving target visual characteristics thereof; selecting one of the geographic regions; in response to the selected geographic region's respective set of device parameters, automatically adapting the device for achieving the selected geographic region's target visual characteristics in the device's enhancement of the images; and enhancing at least one of the images with the adapted device.

12. The system of claim 11, wherein the at least one device is for accepting a different geographic region to become the selected geographic region.

13. The system of claim 12, wherein accepting the different geographic region includes:
determining that the device has moved from the selected geographic region to the different geographic region, so that the different geographic region includes a then-current actual location of the device, wherein the different geographic region is outside the selected geographic region; and
in response to determining that the device has moved from the selected geographic region to the different geographic region, accepting the different geographic region to become the selected geographic region.

14. The system of claim 13, wherein accepting the different geographic region includes:
in response to determining that the device has moved from the selected geographic region to the different geographic region, determining whether a user approves the different geographic region; and
in response to determining that the user approves the different geographic region, accepting the different geographic region to become the selected geographic region.

15. The system of claim 12, wherein accepting the different geographic region includes:
in response to a command that identifies the different geographic region, accepting the different geographic region to become the selected geographic region.

16. The system of claim 15, wherein accepting the different geographic region includes:
in response to the command, determining whether a user approves the different geographic region; and
in response to determining that the user approves the different geographic region, accepting the different geographic region to become the selected geographic region, irrespective of a then-current actual location of the device.

17. The system of claim 11, wherein the at least one device is for revising a particular geographic region's respective set of device parameters.

18. The system of claim 17, wherein revising the particular geographic region's respective set of device parameters includes:
receiving an update to the particular geographic region's respective set of device parameters; and
revising the particular geographic region's respective set of device parameters according to the update.

19. The system of claim 18, wherein revising the particular geographic region's respective set of device parameters includes:
determining whether a user approves the update; and
in response to determining that the user approves the update, revising the particular geographic region's respective set of device parameters according to the update.

20. The system of claim 11, wherein the selected geographic region is different from a then-current actual location of the device.
